(19) United States
(12) Patent Application Publication
(10) Pub. No.: US 2017/0069039 A1
(43) Pub. Date: Mar. 9, 2017

(54) SYSTEM AND METHOD FOR CHARACTERIZING CROWD USERS THAT PARTICIPATE IN CROWD-SOURCED JOBS AND SCHEDULING THEIR PARTICIPATION

(71) Applicant: VoiceBox Technologies Corporation, Bellevue, WA (US)

(72) Inventors: Robert A. KENNEWICK, Seattle, WA (US); Spencer John ROTHWELL, Seattle, WA (US); John GILBERT, Sammamish, WA (US)

(73) Assignee: VoiceBox Technologies Corporation, Bellevue, WA (US)

(21) Appl. No.: 15/256,930

(22) Filed: Sep. 6, 2016

Related U.S. Application Data
(60) Provisional application No. 62/215,117, filed on Sep. 7, 2015.

(51) Int. Cl. G06Q 50/00; G06Q 30/02; G06Q 10/10

(52) U.S. Cl. CPC G06Q 50/01; G06Q 10/1097; G06Q 30/0218

(57) ABSTRACT

A system and method of characterizing crowd users that participate in crowd-sourced jobs based on responses to the jobs, and scheduling their participation based on user-indicated schedules of user availability or system-predicted schedules of user availability. A system may determine a level of quality of a response to a crowd job. The system may use the determined quality of response to determine a reward. The system may schedule a crowd user's participation in a future crowd job. The user may be identified based on the quality of previous responses provided by the user. The system may schedule the user's participation based on explicit input from the user indicating availability and/or based on a system-predicted availability of the user. When the future crowd job is or will be deployed, the system may provide the user with instructions to participate and/or otherwise provide the user with the crowd job.

### CROSS-REFERENCE TO RELATED APPLICATIONS

This application claims priority to U.S. Provisional Patent Application No. 62/215,117, entitled “SYSTEM AND METHOD FOR CHARACTERIZING CROWD USERS THAT PARTICIPATE IN CROWD-SOURCED JOBS AND SCHEDULING THEIR PARTICIPATION,” filed on Sep. 7, 2015, which is incorporated by reference herein in its entirety. This application is related to co-pending PCT Application No. ______, entitled “SYSTEM AND METHOD FOR CHARACTERIZING CROWD USERS THAT PARTICIPATE IN CROWD-SOURCED JOBS AND SCHEDULING THEIR PARTICIPATION,” Attorney Docket No. 45HV-246280, filed concurrently herewith, which is incorporated by reference herein in its entirety.

### FIELD OF THE INVENTION

The invention relates to a system and method for characterizing crowd users that participate in crowd-sourced jobs based on responses to the jobs, and scheduling their participation based on user-indicated schedules of user availability or system-predicted schedules of user availability.

### BACKGROUND OF THE INVENTION

Crowds can generate creative input and other responses for open ended questions and other tasks to be performed. In some instances, the responses may be used as bootstrapping data for Natural Language Understanding (“NLU”) models. The use of unmanaged crowds may be beneficial in other contexts as well.

It is difficult, however, to prevent spam or poor quality users when using crowds. Furthermore, because some crowd sourcing services anonymize their workers (e.g., users who participate in crowd jobs—also referred to herein as “crowd-sourced jobs”), it can be difficult to identify users who provide responses. This make it difficult to reward “good” users better than “bad” users (or not compensate bad users at all).

Furthermore, it can be difficult to schedule particular users, or users having particular skills or interest in certain types of crowd jobs. These and other problems exist for using crowds to build NLU models and other contexts.

### SUMMARY OF THE INVENTION

The invention addressing these and other drawbacks relates to a system and method for characterizing crowd users that participate in crowd-sourced jobs based on responses to the jobs, and scheduling their participation based on user-indicated schedules of user availability or system-predicted schedules of user availability.

A system may determine a level of quality of a response to (e.g., performance of) a crowd job. The response may include an answer to a question posed by a crowd job, a performance of a task specified by the crowd job, and/or other performance relating to a crowd job. The system may use the determined quality of response in various ways. For instance, the system may determine a reward based on the quality of response.

Various techniques may allow identification of users (or at least corresponding end user devices, accounts, etc., associated with users). Thus, the system may reward a user based on his or her quality of response. In some implementations, to obtain the identifying information, the system may communicate with an agent executing at an end user device used by a user to perform a crowd job (and provide a response to the crowd job). The agent may be in the form of a mobile application or other client application that programs the end user device. The agent may communicate identifying information to the system. In these implementations, the computer may associate the identifying information received from end user device with a response to a crowd job.

In some implementations, an entity operating the system may enter into service agreements with a crowd sourcing services to provide identifying information with each response. Such identifying information need not actually identify a user, but rather, an identifier that is used to consistently identify a given user's responses. For example, a crowd sourcing service may associate an external identifier with its internal identifier used to identify a user. Such internal identifier may include payment (account) information associated with compensating a user, a user name, etc.

The external identifier may be used to therefore identify the user (within a crowd sourcing service) but may not be used by the system to actually identify the user. Instead, the system may use the external identifier consistently identify responses from a given user as having originated from the same user (even if the system cannot actually identify the user using the external identifier). Thus the system may associate user responses to crowd jobs based on the external identifier.

In other implementations, the service agreements may specify that a crowd sourcing service provides actual identifying information of the user. In some implementations, the service agreement may specify that the system is able to provide its assessment of a response to a crowd sourcing service. In these implementations, a crowd sourcing service may receive the assessment and apply such assessment to its user.

In some implementations, the system may itself employ crowd jobs without the use of crowd sourcing services. In these implementations, users may register with the system to perform crowd jobs, in which case the system may require identifying information to be used when completing crowd jobs.

In some implementations, the system may build and update a user performance profile based on the quality of previous responses to crowd jobs. In this manner, the system may identify those users who are over-performing or under-performing relative to a benchmark. The benchmark may be predefined and/or be based on an average quality of users based on user performance profiles. In some instances, the system may determine whether to promote a crowd user. Such promotion may entail associating the user with a given role that is beyond that of a non-promoted crowd user. For example, the promotion may entail associating the user with a “crowd manager” role in which the user may validate or otherwise review other crowd users' responses. As such, the system may provide such a crowd manager with access to other crowd users' responses for review. Other types of roles may be assigned as well, depending on a given crowd user's performance.

In some implementations, the system may schedule a crowd user's participation in a future crowd job. The system may do so only for those users whose associated user performance profile indicates that the user is performing above a threshold quality level. In other instances, the system may schedule any user to participate in a future crowd job. The system may schedule the user's participation based on explicit input from the user indicating availability and/or based on a system-predicted availability of the user. Upon scheduling, the system may transmit an invitation to the user an invitation relating to the scheduling (which may or may not require user acceptance) and/or may simply schedule the user's participation. When the future crowd job is to be deployed, the user may be provided with instructions to participate and/or may simply be identified as a crowd user who should receive the crowd job.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system that facilitates characterization of crowd users and scheduling their participation, according to an implementation of the invention.

FIG. 2 illustrates a computer system for characterizing crowd users and scheduling their participation, according to an implementation of the invention.

FIG. 3 illustrates a flow diagram of a process of characterizing crowd users, according to an implementation of the invention.

FIG. 4 illustrates a flow diagram of a process of rewarding crowd users to management roles, according to an implementation of the invention.

FIG. 5 illustrates a flow diagram of a process of scheduling a crowd user's participation in crowd tasks, according to an implementation of the invention.

### DETAILED DESCRIPTION OF THE INVENTION

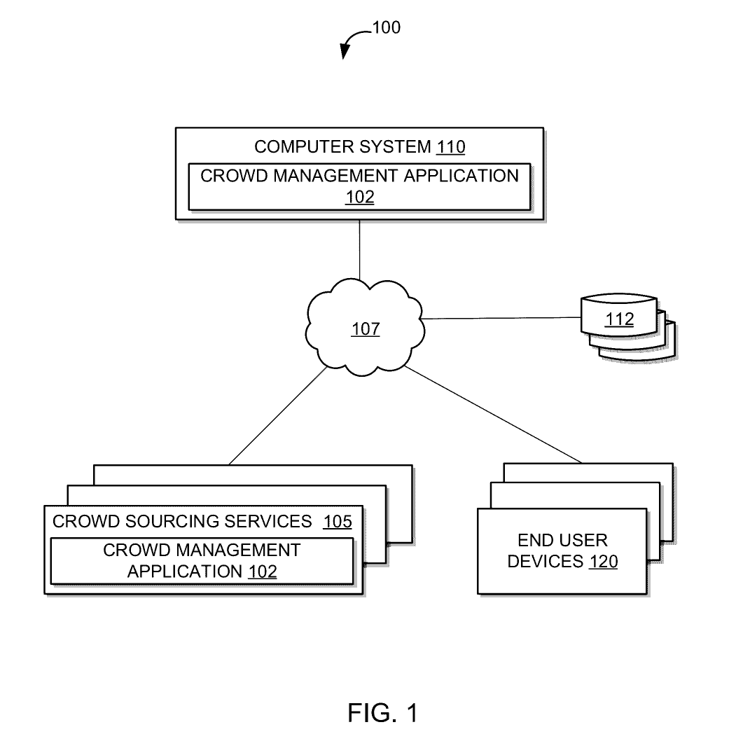

FIG. 1 illustrates a system 100 that facilitates characterization of crowd users and scheduling their participation, according to an implementation of the invention. System 100 may use unmanaged crowds to perform various types of crowd jobs.

A given crowd job may relate to tasks to be completed by an unmanaged crowd. For example, a crowd job may relate to annotating utterances with NER labels, such as described in U.S. Provisional Patent Application Ser. No. 62/215,116, entitled “SYSTEM AND METHOD OF ANNOTATING UTTERANCES BASED ON TAGS ASSIGNED BY UNMANAGED CROWDS,” filed on Sep. 7, 2015, the contents of which is hereby incorporated by reference herein in its entirety. A crowd job may also relate to eliciting open ended natural language responses to questions to train natural language processors, as described in U.S. Provisional Patent Application Ser. No. 62/215,115, entitled “SYSTEM AND METHOD FOR ELICITING OPEN-ENDED NATURAL LANGUAGE RESPONSES TO QUESTIONS TO TRAIN NATURAL LANGUAGE PROCESSORS,” filed on Sep. 7, 2015, the contents of which is hereby incorporated by reference herein in its entirety. A crowd job may also relate to validating utterances and responses, as described in U.S. patent application Ser. No. 14/846,935 (issued as U.S. Pat. No. 9,401,142), entitled “SYSTEM AND METHOD FOR VALIDATING NATURAL LANGUAGE CONTENT USING CROWD SOURCED VALIDATION JOBS,” filed on Sep. 7, 2015, the contents of which is hereby incorporated by reference herein in its entirety. A crowd job may also relate to collecting utterances, as described in U.S. patent application Ser. No. 14/846,926, entitled “SYSTEM AND METHOD OF RECORDING UTTERANCES USING UNMANAGED CROWDS FOR NATURAL LANGUAGE PROCESSING,” filed on Sep. 7, 2015, the contents of which is hereby incorporated by reference herein in its entirety. Other types of crowd jobs may be used as well.

System 100 may determine a level of quality of a response to (e.g., performance of) a crowd job. System 100 may use the quality of response in various ways. For instance, system 100 may determine a reward based on the quality of response. Various techniques may allow identification of users (or at least corresponding end user devices 120, accounts, etc., associated with users). Thus, the system may reward a user based on his or her quality of response.

In some implementations, system 100 may build and update a user performance profile based on the quality of previous responses to crowd jobs. In this manner, system 100 may identify those users who are over-performing or under-performing relative to a benchmark. The benchmark may be predefined and/or be based on an average quality of users based on user performance profiles. In some instances, system 100 may determine whether to promote a crowd user. Such promotion may entail associating the user with a given role that is beyond that of a non-promoted crowd user. For example, the promotion may entail associating the user with a “crowd manager” role in which the user may validate or otherwise review other crowd users' responses. As such, system 100 may provide such a crowd manager with access to other crowd users' responses for review. Other types of roles may be assigned as well, depending on a given crowd user's performance.

In some implementations, system 100 may schedule a crowd user's participation in a future crowd job. System 100 may do so only for those users whose associated user performance profile indicates that the user is performing above a threshold quality level. In other instances, system 100 may schedule any user to participate in a future crowd job. System 100 may schedule the user's participation based on explicit input from the user indicating availability and/or based on a system-predicted availability of the user. Upon scheduling, system 100 may transmit an invitation to the user an invitation relating to the scheduling (which may or may not require user acceptance) and/or may simply schedule the user's participation. When the future crowd job is to be deployed, the user may be provided with instructions to participate and/or may simply be identified as a crowd user who should receive the crowd job.

Having described a high level overview of various system functions, attention will now be turned on an example of a system architecture the facilitates the foregoing and other features and functions described herein.

Exemplary System Architecture

In an implementation, system 100 may include a crowd sourcing service 105, a computer system 110, an crowd database 112, one or more end user devices 120, and/or other components. Each component of system 100 may be communicably coupled to one another by one or more computer networks 107.

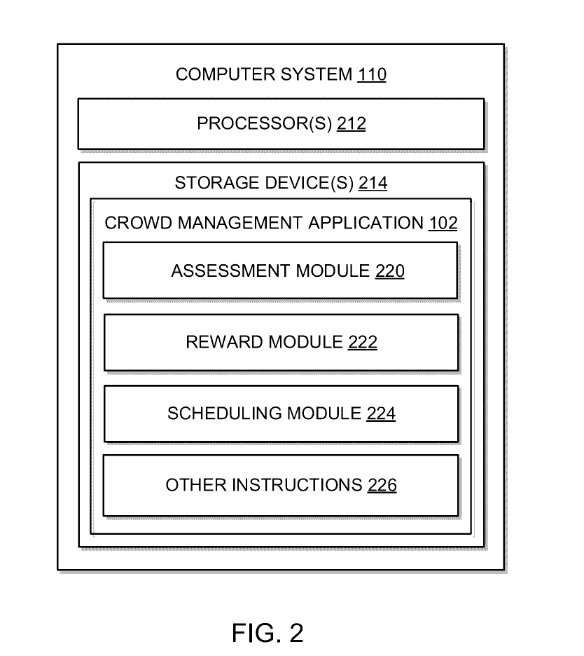

The system may use crowd sourcing services 105 to deploy crowd jobs to users. Such services may include, for example, Amazon Mechanical Turk™, Crowdflower™, and/or other service that facilitates human intelligence tasks from users who participate in completing predefined tasks, typically, though not necessarily, in exchange for compensation. Crowd jobs may be distributed to users via alternative or additional channels (e.g. directly from computer system 110, online marketing, etc.) as well. Crowd sourcing services 105 may include a computing device programmed by crowd management application 102, which is described in more detail with respect to FIG. 2. Alternatively or additionally, computer system 110 may be programmed by crowd management application 102. Crowd management application 102 may program a device of crowd sourcing services 105 and/or computer system 110 to deploy crowd jobs, characterize responses and users, schedule users for other crowd jobs, and/or perform other operations.

Crowd database 112 may be configured to store information relating to the features and functions described herein. For example, and without limitation, crowd database 112 may be configured to store crowd jobs and their associated responses, user performance profiles, various threshold values described herein, crowd job administrator information (e.g., relating to users or entities who create and consume responses of crowd jobs), scheduling information, and/or other information relating to facilitating the characterization and scheduling of crowd users. End user device 120 may be used by crowd users to respond to tasks. Although not illustrated in FIG. 1, end user devices 120 may each include a processor, a storage device, and/or other components. End user device 120 may be programmed to interface with crowd sourcing services 105 and/or computer system 110. In some instances, end user device 120 may be programmed to provide identifying information to crowd sourcing services 105 and/or computer system 110, as will be described below with respect to computer system 110.

Computer System 110

FIG. 2 illustrates a computer system 110 for characterizing crowd users and scheduling their participation, according to an implementation of the invention. Computer system 110 may be configured as a server, a desktop computer, a laptop computer, and/or other device that can be programmed to annotate utterances using unmanaged crowds, as described herein.

Computer system 110 may include one or more processors 212 (also interchangeably referred to herein as processors 212, processor(s) 212, or processor 212 for convenience), one or more storage devices 214 (which may store various instructions described herein), and/or other components. Processors 212 may be programmed by one or more computer program instructions. For example, processors 212 may be programmed by crowd management application 102. As previously noted, crowd management application 102 may also or instead program a device of crowd sourcing services 105.

As illustrated, crowd management application 102 may include an assessment module 220, a reward module 222, a scheduling module 224, and/or other instructions 226 that program computer system 110 to perform various operations. As used herein, for convenience, the various instructions will be described as performing an operation, when, in fact, the various instructions program the processors 212 (and therefore computer system 110) to perform the operation. As previously noted, various types of crowd jobs may be deployed through crowd sourcing services 105. Crowd management application 102 may analyze the results from the crowd jobs and assess users and schedule their participation. Although described with respect to computer system 110, crowd management application 102 may program a computing device of crowd sourcing services 105.

Associating Crowd Responses with Identifying Information

In some crowd sourcing services 105 crowd users are anonymous with respect to entities that employ crowd jobs through such the crowd sourcing services. Thus, oftentimes entities do not know the identity of a given user among the crowd who provided a given response. In an implementation, assessment module 220 may associate identifying information with crowd responses in various ways. The identifying information may relate to a device (e.g., a Media Access Control address, an Internet Protocol address, etc.), a user (e.g., a user name, identifier, etc.), and/or other object that may be associated with a crowd user.

In some implementations, to obtain the identifying information, computer system 110 may communicate with an agent executing at an end user device 120 used by a user to perform a crowd job (and provide a response to the crowd job). The agent may be in the form of a mobile application or other client application that programs the end user device. An example of such an agent is described in U.S. patent application Ser. No. 14/846,926, entitled “SYSTEM AND METHOD OF RECORDING UTTERANCES USING UNMANAGED CROWDS FOR NATURAL LANGUAGE PROCESSING,” which was previously incorporated into this disclosure. Other types of crowd job agents executed at end user device 120 may be used as well.

In some implementations, the agent may communicate identifying information to computer system 110. In these implementations, the computer system 110 may associate the identifying information received from end user device 120 with a response to a crowd job.

In some implementations, an entity operating computer system 110 may enter into service agreements with crowd sourcing services 105 to provide identifying information with each response. Such identifying information need not actually identify a user, but rather, an identifier that is used to consistently identify a given user's responses. For example, a crowd sourcing service 105 may associate an external identifier with its internal identifier used to identify a user. Such internal identifier may include payment (account) information associated with compensating a user, a user name, etc.

The external identifier may be used to therefore identify the user (within crowd sourcing service 105) but may not be used by computer system 110 to actually identify the user. Instead, computer system 110 may use the external identifier consistently identify responses from a given user as having originated from the same user (even if computer system 110 cannot actually identify the user using the external identifier). Thus computer system 110 may associate user responses to crowd jobs based on the external identifier.

In other implementations, the service agreements may specify that crowd sourcing services 105 provides actual identifying information of the user.

In some implementations, the service agreement may specify that computer system 110 is able to provide its assessment of a response to crowd sourcing services 105. In these implementations, crowd sourcing services 105 may receive the assessment and apply such assessment to its user.

In some implementations, computer system 110 may itself employ crowd jobs without the use of crowd sourcing services 105. In these implementations, users may register with computer system 110 to perform crowd jobs, in which case computer system 110 may require identifying information to be used when completing crowd jobs.

Assessing Responses

Assessment module 220 may assess a given response in various ways. For example, responses may be assessed as being of poor quality if the same crowd job tasked to a given user and other users do not have the same response. For instance, assessment module 220 may deem a response to a crowd job to of good quality when two or more users provided the response to the crowd job. Responses from users that do not match those of other users for the same crowd job may be deemed to be of poor quality.

Assessment module 220 may assess a given response by validating the response by launching another crowd job asking another crowd user whether or not the given response was an appropriate one. If another crowd user indicates that the response was appropriate, assessment module 220 may deem the response to be of good quality. If another crowd user indicates that the response was inappropriate, assessment module 220 may deem the response to be of poor quality.

Assessment module 220 may assign a score to a given response based on whether it is deemed to be reliable. Furthermore, assessment module 220 assign a score to a given response based on a scale (e.g., on a scale of 1 to 10, in which 10 is the highest quality score, or vice versa). As described herein for convenience, a higher score will be equated with a higher quality. Whichever type of scale is used, the scale may be based on a number of agreements between different users, a number of validations based on second crowd job employed to validate the response, and/or other metric. In some instances, responses below a given threshold score may be kicked out from consideration (i.e., not used).

Assessing Users

Assessment module 220 may associate scores for each response with identifying information. Assessments of users are described in the examples that follow for convenience and not limitation. Devices or other objects identified by the identifying information may be assessed as well.

Assessment module 220 may build and update user scores based on the quality of previous response scores assigned to responses provided by a user. For instance, assessment module 220 may increase the user score as a function of the number of responses that the user provided that agreed with other users' responses for the same crowd job. Likewise, assessment module 220 may decrease the user score as a function of the number of responses that the user provided that disagreed with other users' responses for the same crowd job.

Assessment module 220 may build and update user scores based on a quality of responses to enhanced Completely Automated Public Turing test to tell Computers and Humans Apart (“CAPTCHA”) challenges from the user. In some instances, assessment module 220 may use enhanced CAPTCHAs, which are described more fully by the system disclosed in U.S. patent application Ser. No. 14/846,923, entitled “SYSTEM AND METHOD OF PROVIDING AND VALIDATING ENHANCED CAPTCHAS,” filed on Sep. 7, 2015, the contents of which are hereby incorporated herein in its entirety.

Some of the enhanced CAPTCHAs disclosed in the foregoing use challenges that require certain knowledge of a given subject matter in order to be validated (and start or continue using a resource). In this context, using such enhanced CAPTCHAs, computer system 110 may score users in crowds based on basic knowledge of a given domain.

In other instances, enhanced or other CAPTCHAS may be used to periodically validate users in a crowd during a given task and/or in between tasks to ensure that the user is a human user and/or verify that the user has some knowledge relating to the domain. Assessment module 220 may generate or update the user score based on performance on the enhanced CAPTCHAs. For instance, assessment module 220 may reduce or increase the user score as a function of the number of failed or validated enhanced CAPTCHA validations.

Assessment module 220 may build and update user scores based on a number or consistency of “correct” responses to test questions. For instance, some crowd jobs may have predefined and known “correct” answers to test questions, which may be used to judge whether a given user who provided a response to such a test question is a good quality user (e.g., a user who provided the correct answer may have his or her score positively impacted). In particular assessment module 220 may reduce or increase the user score as a function of the number of incorrect or correct answers to test questions.

Assessment module 220 may build and update user scores based on a number of responses from the user that were unused. For instance, a response may be unused when it does not match another user's response for the same crowd job, as previously described. Accordingly, assessment module 220 may reduce or increase the user score as a function of the number of unused responses from the user.

Rewarding Users Based on Performance in Crowd Jobs

In an implementation, reward module 222 may reward a user based on the quality of response provided by the user. A reward may include compensation of value (e.g., monetary) or perceived value (e.g., a virtual item), an assignment of a given role to a user (e.g., a crowd manager role), and/or other benefit conferred to a user.

Whichever type of reward is provided, a user providing a correct response may be rewarded better (e.g., more) than a user who provided an incorrect (or less correct) response. In particular, reward module 222 may reward a user based on the aforementioned response score. In this manner, higher quality responses may be associated with better rewards than lower quality responses.

In an implementation, reward module 222 may assign users to different tiers, which may each be associated with its own level of rewards. In tiered reward implementations, reward module 222 may provide certain levels of rewards to users within their assigned tiers. Reward module 222 may assign a user to a tier based on a user score, level of participation, and/or metric. For example, user scores within a first range may be placed into a first tier, user scores within a second range may be placed into a second tier, and so on. Likewise, level of participation (e.g., number or percentage of high quality responses—e.g., those with response scores above a threshold value—provided) within a first range may be placed into a first tier and so on. Reward module 222 may combine multiple metrics to assign a user into a reward tier. Such combinations may use weights to account for the importance of any combined metric.

In an implementation, reward module 222 may assign a user to a particular role based on the user's user score. For instance, a user whose user score exceeds a threshold value may be provided with a crowd manager (or other role). Such an enhanced role may be associated with greater compensation, as well as, or alternatively, additional capabilities provided to the user. For instance, a crowd manager (e.g., a user associated with a crowd manager role) may be provided with an ability to access and validate other users' responses, order a new set of crowd jobs (e.g., in cases where the crowd manager invalidated a number of responses), provide assessments of other users, and/or perform other tasks.

In an implementation, reward module 222 may assess and validate the activity of crowd managers by causing their activities to be audited. In some instances, crowd managers may be stripped of their crowd manager roles if their activity is deemed to be unsatisfactory. For example, crowd managers may be assigned with a crowd manager score. If such score indicates that the performance of the crowd manager is unsatisfactory (e.g., below a threshold score), then the crowd manager may be demoted to a regular user.

Scheduling Participation

In an implementation, scheduling module 224 may schedule a user's participation in a crowd job. For instance, scheduling module 224 receive, from the user, an indication of a time and/or date (described hereinafter as simply “time” for convenience) at which the user will be available and willing to participate in a crowd job. In some instances, the user may specify which types of crowd job he or she wishes to participate in for that time. For example, the user may specify certain subject matter of crowd tasks to perform or types of activities required of the task.

In an implementation, scheduling module 224 may schedule a user's participation in a crowd job based on a prediction of when a user will be available to participate in a crowd job. Alternatively or additionally, scheduling module 224 may predict a type of crowd job the user will likely be interested in participating. Scheduling module 224 may predict the time and/or the type of crowd job of interest based on previous participation in crowd jobs by the user. For instance, scheduling module 224 may determine that a particular user tends to participate in crowd jobs in the evenings and on Saturdays and therefore predict that the user will be available on similar days.

Likewise, scheduling module 224 may determine that a particular user tends to participate in particular types of crowd jobs. Alternatively or additionally, scheduling module 224 may determine the types of crowd jobs in which the user excels. For instance, scheduling module 224 may determine types of crowd jobs for which the user's response scores are above an acceptable threshold score.

In some instances, scheduling module 224 may pre-schedule a number of users to participate in crowd jobs based on a number of crowd jobs that are scheduled or anticipated to be performed. For instance, a crowd job administrator may provide a schedule of crowd jobs to be employed. Scheduling module 224 may pre-schedule a number of users to participate in order to most efficiently perform the job and/or to appropriately match certain users (e.g, with an interest in certain types of jobs) with certain crowd jobs.

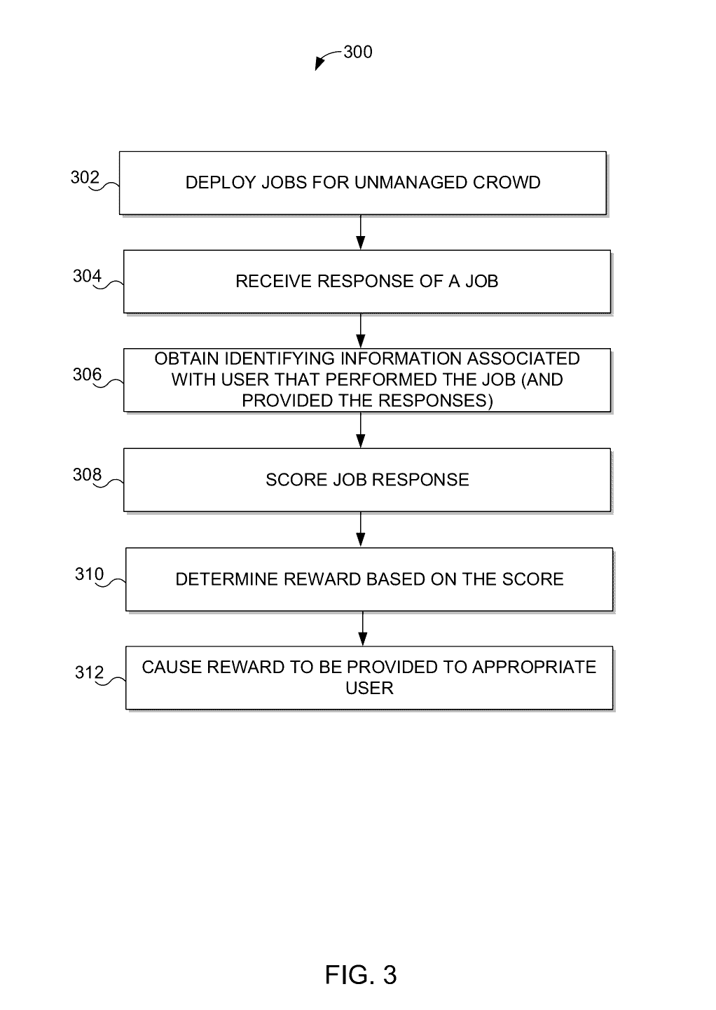

FIG. 3 illustrates a flow diagram of a process 300 of characterizing crowd users, according to an implementation of the invention.

In an implementation, in an operation 302, process 300 may include deploying jobs for an unmanaged crowd. In an implementation, in an operation 304, process 300 may include receiving a result of a job.

In an implementation, in an operation 306, process 300 may include obtaining identifying information associated with a user that performed the job. The identifying information may alternatively (or additionally) identify an end user device used to complete the crowd job.

In an implementation, in an operation 308, process 300 may include scoring the result. In an implementation, in an operation 310, process 300 may include determining a reward based on the score. In an implementation, in an operation 312, process 300 may include causing the reward to be provided to the appropriate user. In some instances, the reward may be provided through a crowd sourcing service 105. For instance, process 300 may include transmitting information, in association with the response or identifier for the response, that specifies the reward to crowd sourcing service 105, which conveys the reward to the user. In other instances, the reward may be provided directly to the user.

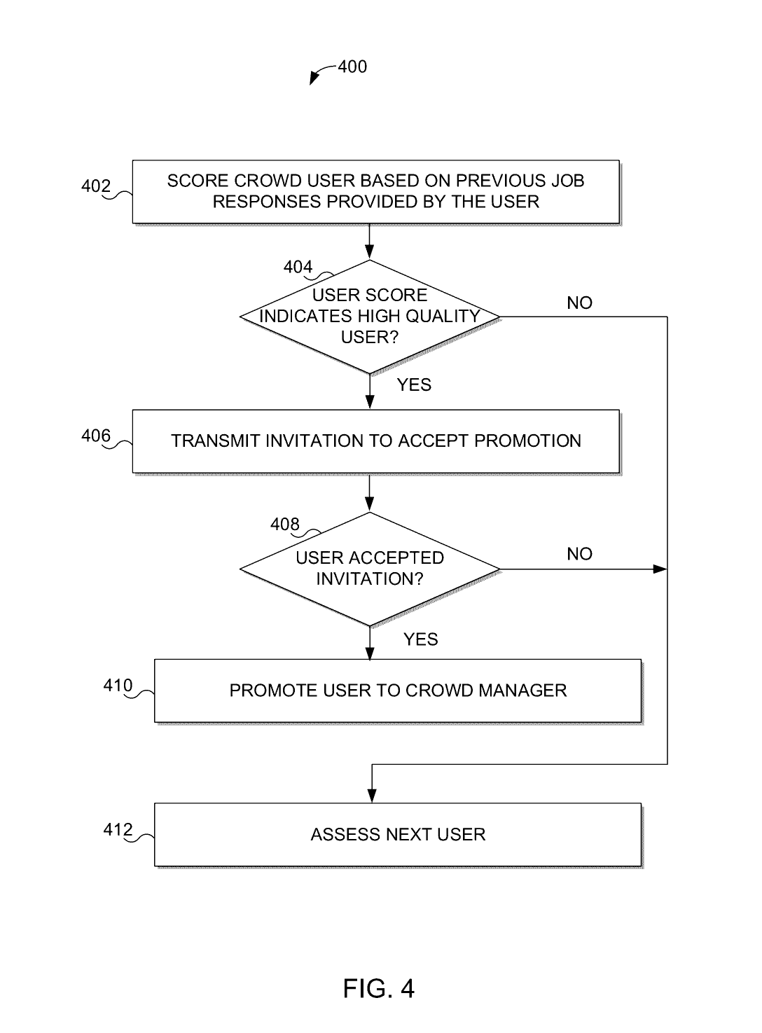

FIG. 4 illustrates a flow diagram 400 of a process of rewarding crowd users to management roles, according to an implementation of the invention.

In an implementation, in an operation 402, process 400 may include scoring a user from a crowd based on previous job responses provided by the user. The user score may be based on previous response scores, a number of responses, and/or other metric.

In an implementation, in an operation 404, process 400 may include determining whether the user score indicates a high quality user (e.g., whether the user score exceeds a threshold value).

In an implementation, responsive to a determination that the user score indicates a high quality user, in an operation 406, process 400 may include transmitting an invitation to accept a promotion (e.g., a particular user role such as a crowd manager role).

In an implementation, in an operation 408, process 400 may include determining whether the user accepted the invitation.

In an implementation, responsive to a determination that the user accepted the invitation, in an operation 410, process 400 promoting the user to a crowd manager (or other type of role).

In an implementation, responsive to a determination that the user score does not indicate a high quality user or a determination that the user has declined the invitation, in an operation 412, process 400 may include assessing a next user.

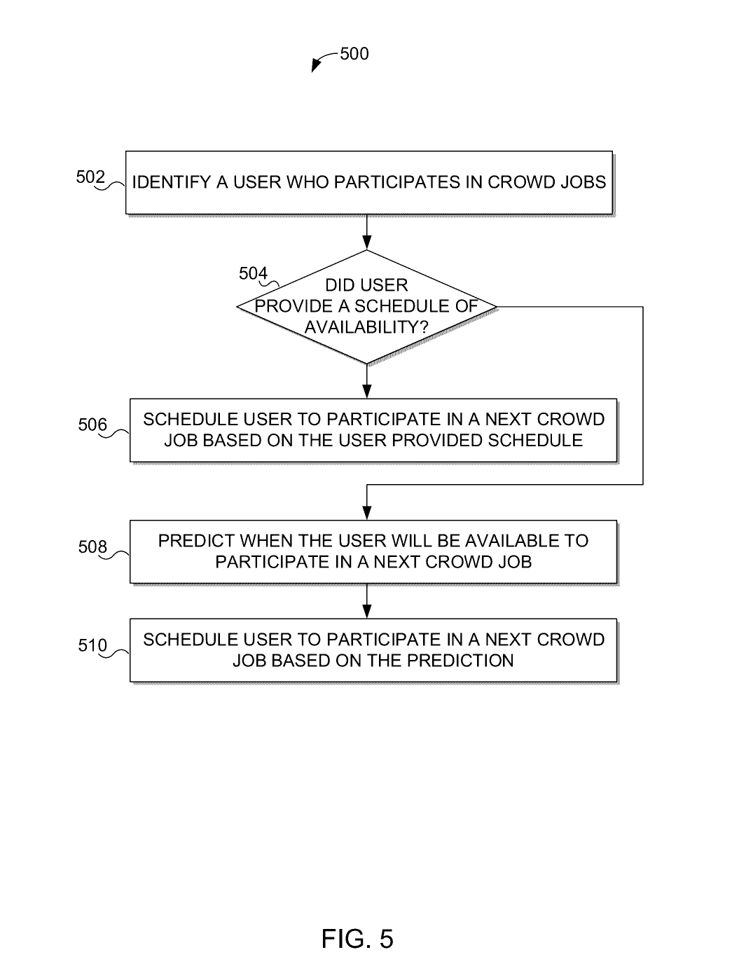

FIG. 5 illustrates a flow diagram of a process 500 of scheduling a crowd user's participation in crowd tasks, according to an implementation of the invention.

In an implementation, in an operation 502, process 500 may include identifying a user who participates in crowd jobs. In some instances, only high quality users (as described herein) may be identified.

In an implementation, in an operation 504, process 500 may include determining whether the identified user provided a schedule of availability. Alternatively or additionally, process 500 may include determining whether the user provided a preferred type of crowd job in which the user would like to participate.

In an implementation, responsive to a determination that the user provided a schedule of availability (and/or preferred type of crowd job), in an operation 506, process 500 may include scheduling the user to participate in a next crowd job based on the provided schedule. For instance, the user may be scheduled to participate in a crowd job to be employed (or is currently being employed) during a time that the user indicated availability.

In an implementation, responsive to a determination that the user has not provided a schedule of availability (and/or preferred type of crowd job), in an operation 508, process 500 may include predicting when the user will be available to participate in a crowd job and/or the type of crowd job in which the user will be interested.

In an implementation, in an operation 510, process 500 may include scheduling the user to participate in a crowd job based on the prediction. For instance, the user may be scheduled to participate in a crowd job to be employed (or is currently being employed) during a predicted time of user availability.

It should be noted that prior to actually providing the user with a scheduled crowd job, the user may be invited to (and be given an opportunity to decline) such scheduling or participation.

As used herein, crowd jobs are “deployed” or otherwise provided to users via a crowd sourcing service 105 by causing information that specifies the crowd job to be transmitted to the crowd sourcing service, such as via a network 107. Likewise, responses (also referred to herein as “annotations”) to crowd jobs may be received from crowd sourcing service 105 in the form of information transmitted over the network which conveys the responses.

The one or more processors 212 illustrated in FIG. 2 may each include one or more physical processors that are programmed by computer program instructions. The various instructions described herein are exemplary only. Other configurations and numbers of instructions may be used, so long as the processor(s) 212 are programmed to perform the functions described herein.

Furthermore, it should be appreciated that although the various instructions are illustrated in FIG. 2 as being co-located within a single processing unit, in implementations in which processor(s) 212 includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 212 may be programmed by one or more additional instructions that may perform some or all of the functionality attributed herein to one of the instructions.

The various instructions described herein may be stored in a storage device 214, which may comprise random access memory (RAM), read only memory (ROM), and/or other memory. The storage device may store the computer program instructions (e.g., the aforementioned instructions) to be executed by processor 212 as well as data that may be manipulated by processor 212. The storage device may comprise floppy disks, hard disks, optical disks, tapes, or other storage media for storing computer-executable instructions and/or data.

The various databases described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The various components illustrated in FIG. 1 may be coupled to at least one other component via a network 107, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various processing operations and/or data flows depicted in FIG. 3 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer implemented method of assessing responses to crowd-sourced jobs and assessing crowd users, the method being implemented in an end user device having one or more physical processors programmed with computer program instructions that, when executed by the one or more physical processors, cause the end user device to perform the method, the method comprising:
receiving, by the computer system, a response to a crowd-sourced job in which a plurality of crowd users are tasked to respond to the crowd-sourced job;
generating, by the computer system, a response score for the response;
associating, by the computer system, the response with identifying information associated with a user;
determining, by the computer system, a reward based on the response score; and
causing, by the computer system, the reward to be provided to the user.

2. The method of claim 1, wherein the identifying information associated with the user relates to a user identifier, or an end user device identifier.

3. The method of claim 1, wherein determining the reward based on the response score comprises:
generating or updating, by the computer system, a user score based on the response score, wherein the reward is based on the user score.

4. The method of claim 1, wherein the reward to be provided comprises a monetary value.

5. The method of claim 1, the method further comprising:
receiving, by the computer system, a second response to the crowd-sourced job;
generating, by the computer system, a second response score for the response;
associating, by the computer system, the second response with second identifying information associated with a second user;
determining, by the computer system, a second reward based on the second response score, wherein the second reward is different than the first reward; and
causing, by the computer system, the second reward to be provided to the second user.

6. The method of claim 1, wherein the reward to be provided comprises a monetary value.

7. The method of claim 1, wherein the reward to be provided comprises an assignment of a particular user role to the user.

8. The method of claim 7, wherein causing the reward to be provided to the user comprises:
granting, by the computer system, the user with access to at least one other user's response to the crowd job or one or more other crowd jobs; and
allowing, by the computer system, the user to validate the at least one other user's response to the crowd job or one or more other crowd jobs.

9. The method of claim 1, the method further comprising:
receiving, by the computer system, from the user, an indication of a date or time that the user will be available to participate in a future crowd job; and
scheduling, by the computer system, the user's participation in a second crowd job based on the indication of the date or time from the user and a date or time associated with the second crowd job.

10. The method of claim 1, the method further comprising:
determining, by the computer system, a prediction of a date or time that the user will be available to participate in a future crowd job; and
scheduling, by the computer system, the user's participation in a second crowd job based on the prediction of the date or time and a date or time associated with the second crowd job.

11. A system of assessing responses to crowd jobs and assessing crowd users, the comprising:
a computer system having one or more physical processors programmed with computer program instructions that, when executed by the one or more physical processors, cause the end user device to:
receiving, by the computer system, a response to a crowd-sourced job in which a plurality of crowd users are tasked to respond to the crowd-sourced job;
generating, by the computer system, a response score for the response;
associating, by the computer system, the response with identifying information associated with a user;
determining, by the computer system, a reward based on the response score; and
causing, by the computer system, the reward to be provided to the user.

12. The system of claim 11, wherein the identifying information associated with the user relates to a user identifier, or an end user device identifier.

13. The system of claim 11, wherein to determine the reward based on the response score, the computer system is further programmed to:
generating or updating, by the computer system, a user score based on the response score, wherein the reward is based on the user score.

14. The system of claim 11, wherein the reward to be provided comprises a monetary value.

15. The system of claim 11, wherein the computer system is further programmed to receive a second response to the crowd-sourced job;
generate a second response score for the response;
associate the second response with second identifying information associated with a second user;
determine a second reward based on the second response score, wherein the second reward is different than the first reward; and
cause the second reward to be provided to the second user.

16. The system of claim 11, wherein the reward to be provided comprises a monetary value.

17. The system of claim 11, wherein the reward to be provided comprises an assignment of a particular user role to the user.

18. The system of claim 17, wherein to cause the reward to be provided to the user, the computer system is further programmed to:
grant the user with access to at least one other user's response to the crowd job or one or more other crowd jobs; and
allow the user to validate the at least one other user's response to the crowd job or one or more other crowd jobs.

19. The system of claim 11, wherein the computer system is further programmed to:
receive, from the user, an indication of a date or time that the user will be available to participate in a future crowd job; and
schedule the user's participation in a second crowd job based on the indication of the date or time from the user and a date or time associated with the second crowd job.

20. The system of claim 11, wherein the computer system is further programmed to:
determine a prediction of a date or time that the user will be available to participate in a future crowd job; and
schedule the user's participation in a second crowd job based on the prediction of the date or time and a date or time associated with the second crowd job.
